(19) United States
(12) Patent Application Publication
(10) Pub. No.: US 2019/0061558 A1
(43) Pub. Date: Feb. 28, 2019

(54) SYSTEMS AND METHODS FOR SENSING PARAMETERS ON MOVERS IN LINEAR MOTOR SYSTEMS

(71) Applicant: ROCKWELL AUTOMATION TECHNOLOGIES, INC., Mayfield Heights, OH (US)

(72) Inventor: James A. Craver, Gilford, NH (US)

(21) Appl. No.: 15/692,806

(22) Filed: Aug. 31, 2017

(51) Int. Cl. B60L 15/00

(52) U.S. Cl. CPC B60L 15/005; B60L 15/025

(57) ABSTRACT

The subject matter of the disclosed invention relates to systems a methods for applying a sensor to linear motor systems. In various embodiments, the disclosed method relates to providing closed loop control on a mover with or without a payload by detecting parameters of the mover, payload, or both.

### BACKGROUND

The invention relates generally relates to linear motor systems. Specifically, this invention relates to sensing parameters of one or both of the mover and the payload in a linear motor system.

Linear motor systems are known and in use for many different applications. In most such systems, a track is arranged in a desired layout to covey materials via movers that are displaced along the track by field interaction between controllable coils and permanent magnets. The location, speed, velocity, and other motion aspects may be controlled by control of the application of power to the coils. Each mover, which may be configured as a “stage” or other support structure may carry a payload, such as an article of manufacture, a vessel to be filled, a parcel or package to be processed, or any other load that is place on the mover as a desired location and at some point removed from it.

Despite improvements in such systems, there is currently little or no ability to sense parameters of the movers or of the payloads. Current product offerings may allow for detection of motion parameters by reference to feedback, but little or no other information is currently available, and particularly from direct sensing using components on or in the mover assemblies. There is a continuing need for innovation in these systems that may allow for the gathering of useful information relating to linear motor movers and their payloads.

### BRIEF DESCRIPTION

The disclosure sets forth a system comprising a linear motor track comprising a plurality of coils and control circuitry that, in operation, selectively energizes the coils to create a motive field. A mover is disposed on the track and comprises a magnet that interacts with the motive field to drive the mover along the track under control of the control circuitry, the mover, in operation, transporting a payload along the track. A sensor is disposed on or in the mover that, in operation, detects a parameter of the mover or of the payload or both. Wireless transmission circuitry is coupled to the sensor that, in operation, transmits data based upon the parameter detection by the sensor. Wireless receiver circuitry is disposed on or near the track that, in operation, receives and processes the data transmitted by the wireless transmission circuitry.

The disclosure also related to a system comprising a mover configured to be disposed on a linear motor track that comprises a plurality of coils and control circuitry that, in operation, selectively energizes the coils to create a motive field, the mover comprising a magnet that interacts with the motive field to drive the mover along the track under control of the control circuitry, the mover, in operation, transporting a payload along the track. A sensor is disposed on or in the mover that, in operation, detects a parameter of the mover or of the payload or both. Wireless transmission circuitry is coupled to the sensor that, in operation, transmits data to receiver circuitry on or near the track based upon the parameter detection by the sensor.

Still further, the disclosure relates to a method comprising disposing a mover on a linear motor track that comprises a plurality of coils and control circuitry that, in operation, selectively energizes the coils to create a motive field, the mover comprising a magnet that interacts with the motive field to drive the mover along the track under control of the control circuitry, the mover, in operation, transporting a payload along the track. A parameter of the mover or of the payload or both is detected via a sensor disposed on or in the mover. Finally, data is wirelessly transmitted from the mover to receiver circuitry on or near the track based upon the parameter detection by the sensor.

### DRAWINGS

These and other features, aspects, and advantages of the present disclosure will become better understood when the following detailed description is read with reference to the accompanying drawings in which like characters represent like parts throughout the drawings, wherein:

FIG. 1A is a perspective view of an exemplary transport system illustrating straight and curved track modules and several movers positioned for movement along the modules;

FIG. 1B is a top view of a similar transport system in which motor coils are positioned differently than in the system of FIG. 1A;

FIG. 2 is a diagrammatical representation of the system of FIGS. 1A and 1B;

FIG. 3 is a diagrammatical representation of the signal transmitting and receiving circuitry with the sensor package;

FIG. 4 is a schematic representation of a sensor package containing a temperature sensor;

FIG. 5 is a schematic representation of a sensor package containing a weight sensor;

FIG. 6A is a schematic representation of a sensor package containing a photo sensor or camera for monitoring a payload;

FIG. 6B is a schematic representation of a sensor package containing a photo sensor or camera for monitoring the mover;

FIG. 6C is a schematic representation of a sensor package containing a photo sensor or camera for monitoring an object external to the mover;

FIG. 7 is a schematic representation of a sensor package containing a accelerometer;

FIG. 8A is a schematic representation of a sensor package containing a proximity or presence sensor for detecting a payload;

FIG. 8B is a schematic representation of a sensor package containing a proximity or presence sensor for detecting external objects, landmarks, etc.

FIG. 9 is a schematic representation of a sensor package containing a power supply comprising a battery charging system;

FIG. 10 is a schematic representation of a sensor package containing a power supply comprising an coil charging system;

FIG. 11 is a schematic representation of a sensor package with a power supply containing a coil passing over coils on the track system;

FIG. 12 is a schematic representation of a sensor package powered by a photocell;

FIG. 13 is a schematic representation of a sensor package with a power supply containing a coil passing stationary magnets;

FIG. 14 is a schematic representation of a sensor package passing a scanner or reader; and

FIG. 15 is a schematic representation of logical arguments between the sensor package and receiving and transmitting circuitry.

### DETAILED DESCRIPTION

While only certain features of the invention have been illustrated and described herein, many modifications and changes will occur to those skilled in the art. It is, therefore, to be understood that the appended claims are intended to cover all such modifications and changes as fall within the true spirit of the invention.

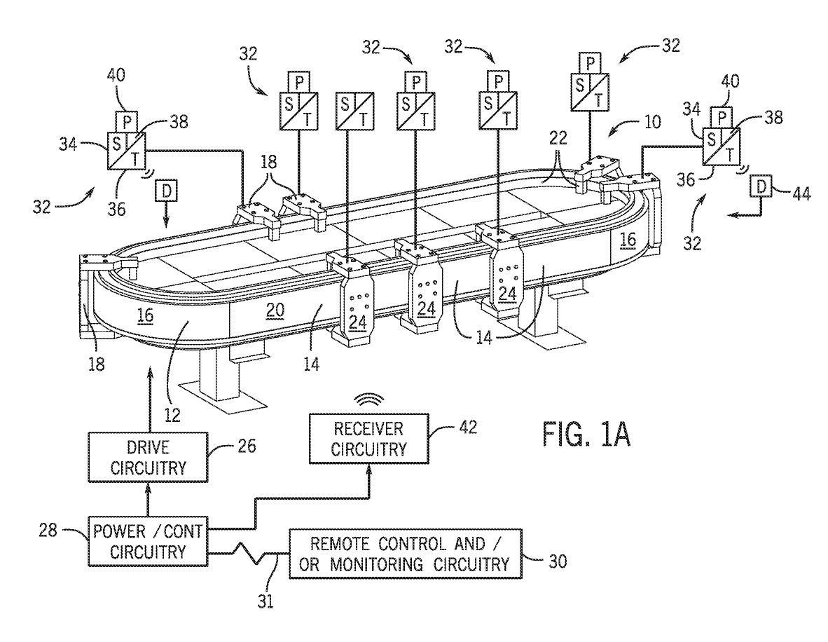

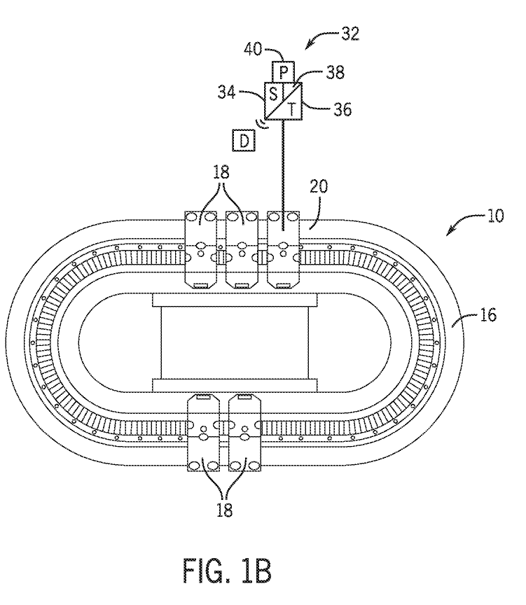

Turning now to the drawings, and referring first to FIG. 1A, a transport system 10 as illustrated for moving articles or products around a track 12. As will be appreciated by those skilled in the art, in many applications, the transport system will be configured to inter-operate with other machines, robots, conveyers, control equipment, and so forth (not separately shown) in an overall automation, packaging, material handling or other application. The transport system itself generally comprises a “linear motor” system as discussed below, in which the moving components are positioned, accelerated, decelerated, and generally moved under the influence of controlled magnetic and electromagnetic fields. In the illustrated embodiment, the track 12 comprises straight track modules 14 and curved track modules 16. These modules may be generally self-contained and mountable in various physical configurations, such as the oval illustrated in FIG. 1A. It should be noted that other configurations are equally possible as discussed below. The configurations may form closed loops of various shapes, but may also comprise open-ended segments. The system further comprises one or more movers 18 which are mounted to and movable along the track. Again, the position, velocity, acceleration, and higher order derivative parameters are controllable for these movers by appropriate control of the coils of the system that are energized and de-energized as discussed below. In the illustrated embodiment, the movers 18 interact with stationary elements in and around an outer periphery 20 of the track modules, although other configurations are envisaged. A sensor system 22 is provided to detect positions of the movers around the track, and such center systems may comprise permanent magnets, energized coils, Hall effect sensors, or any other suitable devices. In general, one component of the sensor system will be mounted on the movers, while another component will be mounted at fixed locations around the track.

Each mover further comprises a mounting platform 24. In an actual implementation, various tools, holders, support structures, loads, and so forth may be mounted to this mounting platform. The movers themselves may be configured differently from those shown in order accommodate the various loads. While a horizontal configuration is illustrated in FIG. 1A, other orientations may also be provided, such as ones in which the illustrated oval is generally stood on a side or end, or at any angle between.

The system further comprises circuitry for controlling a movement of the movers. In the embodiment illustrated in FIG. 1A, this circuitry includes a drive circuitry 26 that provides signals to each track module, and specifically individual coils (see below) of the track modules to create electromotive forces that interact with magnets on the modules to drive the modules to specific locations, and at specific velocity, accelerations, and so forth. This drive circuitry may typically include inverter circuitry that makes use of power electronic switches to provide drive power to the individual coils of each module in a controlled manner. In some embodiments, the drive circuitry may be included in each individual module, and signals provided to the drive circuitry by power and control circuitry 28. This power and control circuitry (and the drive circuitry) may receive feedback from the movers and/or from the sensor system to detect the location, velocity, acceleration, and so forth of each mover. In certain embodiments the movers may also be configured to be recognized by the power and control circuitry 28 as individual axes that are independently controlled, but with regulation of their position, velocity and acceleration to avoid conflicts, collisions, and so forth. The particular motion profile implemented by the power and control circuitry 28 will typically be configured and implemented upon the design and commissioning of the system, here again, depending upon the particular task to be performed. Finally, various remote control and/or monitoring circuitry 30 may be provided and this circuitry may be linked to the system by one or more networks 31. Such remote circuitry may generally allow for coordination of the operation of the transport system with other automation components, machine systems, manufacturing and material handling machines, and so forth.

Each mover comprises a sensor package 32 disposed on the mounting platform 24, with each sensor package 32 comprising a sensor 34. The number of type of sensor 34 will depend on the desired variable to be measured, for example, acceleration, presence, proximity, temperature, weight, photosensor, camera, or mover ID. The information from the sensor pack is transmitted via transmission circuitry. Each sensor 34 is powered by a power supply 38. The power supply may provide power for the operation of the sensor 34, the transmission circuitry 36, or both. The mover also includes a payload 40. The sensor 34 may also detect variables of the payload 40 or in combination with the mover.

FIG. 1B illustrates an alternative configuration for a similar transport system. However, in this configuration, rather than motor coils being positioned around the periphery of the system, coils are positioned around the top of the system, in a generally planar arrangement. Magnet assemblies of each mover 16 face these coils and are spaced from the coils by a small air gap. Straight and curved track modules are assembled, as above, to form an oval, although other shapes and layouts may be formed. The curved track modules may be adapted with modified spline geometries, as in the case of the system shown in FIG. 1A, and as described in greater detail below.

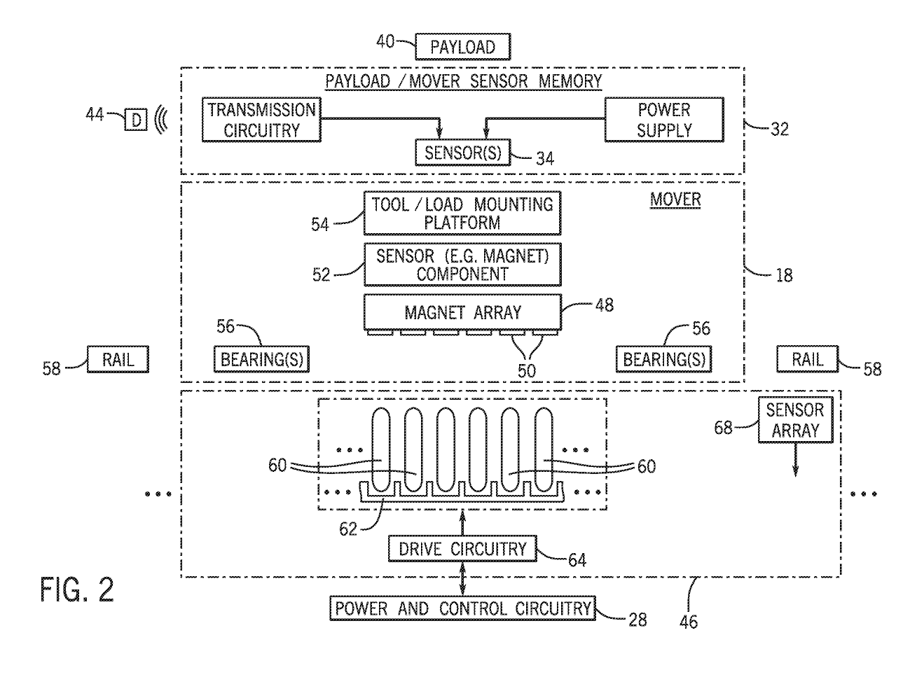

FIG. 2 is a diagrammatical representation of the transport system showing one track module 46, one mover 18 positioned along the track module, and one payload 40 positioned on top of the mover. The track module illustrated in FIG. 2 may be a straight or curved track module, these two differing in their physical configuration, and certain of the actual characteristics owing to the curved nature of the curved modules as discussed below. In general, however, each mover comprises a magnet array 48 on which a number of magnets 50 are mounted. These will typically be permanent magnets and are mounted such that a small air gap is provided between the magnets and coils of the track module described below. As shown in FIG. 2, the track module 46 further comprises a sensor component 52, such as a permanent magnet. It should be noted, however, that the particular sensor component included in the track module will depend upon the nature of the sensing strategy, the sensing resolution, the position of the sensor on the mover (and cooperating components on the track module), and so forth. The platform 54 is provided on the mover while mounting tools and the like as discussed above. Finally, bearings and associated components (e.g., rollers) are mounted to the mechanical structure of the mover and serve to interact with one or more rails, as indicated by reference numerals 56 and 58, respectively. These bearings and rails allow the mover to remain securely attached to the track modules while allowing relatively free movement of the movers along the track modules and supporting mechanical loads and forces encountered during motion.

The track module 46 will typically include a series of parallel coils 50 that are associated with a stator or armature 62. In currently contemplated embodiments, these coils are mounted into slots in the stator, and the stator itself may be made of magnetic material formed into a stack of laminates and structured to allow for mounting within the track module housing. Particular configurations, magnetic, mounting structures and the like of the coils and stator components are generally beyond the scope of the present disclosure. Drive circuitry 64 may be included in each module as discussed above to allow for controlled power signals to be applied to the coils in order to drive and position the movers appropriately around the track module. Finally, a sensor array 66 is provided in each track module to allow for interaction with the sensor components of the movers. This sensor array will typically provide feedback that can indicate the position of the movers, and can be used to derive velocity, acceleration, jerk and other motion parameters. In the illustrated embodiment a plurality of track modules may be mounted end-to-end and interconnected with one another and/or with the power and control circuitry to received signals used to power the coils.

As will be appreciated by those skilled in the art, track modules, along with the magnet arrays of the movers, will generally form what may be considered a linear motor system. That is, electromotor force is generated by the controlled fields of the coils and interaction between these fields and the magnetic fields of the magnet array serve to drive the mover into desired positions, at desired speeds, and so forth. As noted above, these coils and the linear motor itself may be designed in accordance with various configuration strategies, such as ones having the coils arranged around a periphery of the track modules, ones in which the coils are generally planar (in a top or bottom position of the modules), and so forth. Although the “linear” motor system may be used in the present disclosure, it should be appreciated that curved modules in various configurations are intended to be included under this rubric.

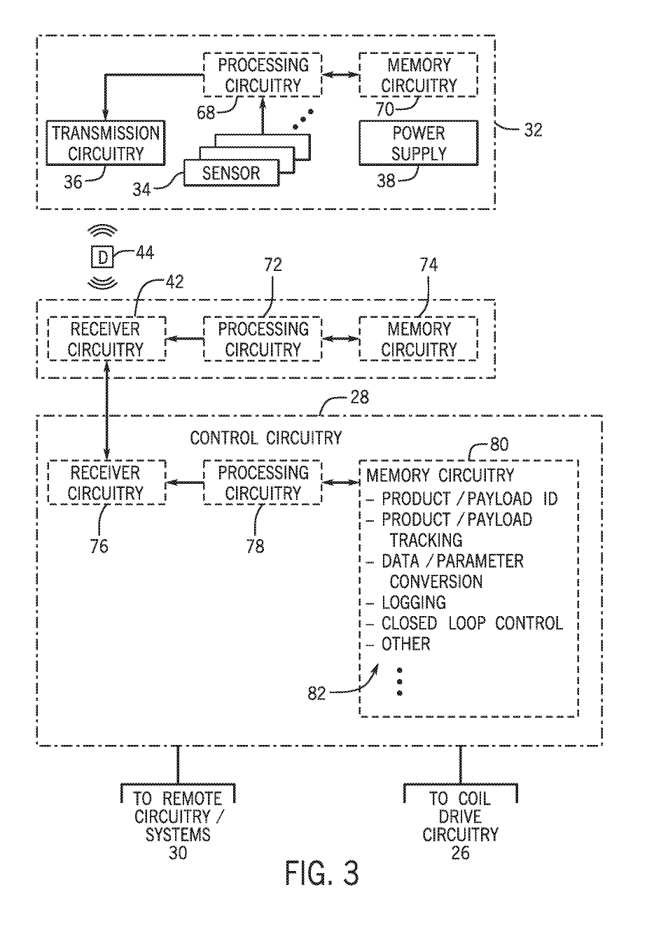

FIG. 3 is a diagrammatical representation of the circuitry network for sensor transmitting and receiving system showing one sensor package 32, one receiver circuitry 42, and one power/control circuitry 28. Information, or data, obtained from the one of more sensors 34 is handled by processing circuitry 68 and/or stored in memory circuitry 70. The transmission circuitry transmits the data 44 to the receiving circuitry 42. The transmission circuitry may transmit data 44 via wireless Ethernet, Bluetooth, or NFC. The data is handled by the processing circuitry 72 and the memory circuitry 74. In one embodiment, information obtained from the sensors may be used to modify parameters of the mover 18 or the data 44 may be transmitted to receiving circuitry 42 external to the mover.

Data from the receiver circuitry 42 is linked to the control circuitry 28 through interface circuitry 76. The control circuitry 28 sends signals to remote circuitry systems 30 and the coil drive circuitry 26 which allows for closed loop control of the linear motor system. Control circuitry 28 can alter the parameters of the mover 18 based on the data 44 transmitted from the transmission circuitry of the sensor package 32. This data is received by the interface circuitry 76 and processed via processing circuitry 78 based routines or protocols 82 stored in the memory circuitry 80. Exemplary routines or protocols are product/payload ID, product/payload tracking, data/parameter conversion, logging, and closed loop control. For example, the routines 82 comprise identifying the payload or product, tracking the payload or product. This can be useful in embodiments where the linear motor system is used for transporting movers through multiple steps. For instance, if the movers disposed on the track all have a unique ID and an error were to occur at some stage of the track, it would possible to know which payloads 40 or movers 18 would need to removed or fixed so that the error does not propagate throughout the entire linear motor system. However, data 44 processed by the network of circuitry is not only for closed loop control but also may be stored or record keeping or monitoring.

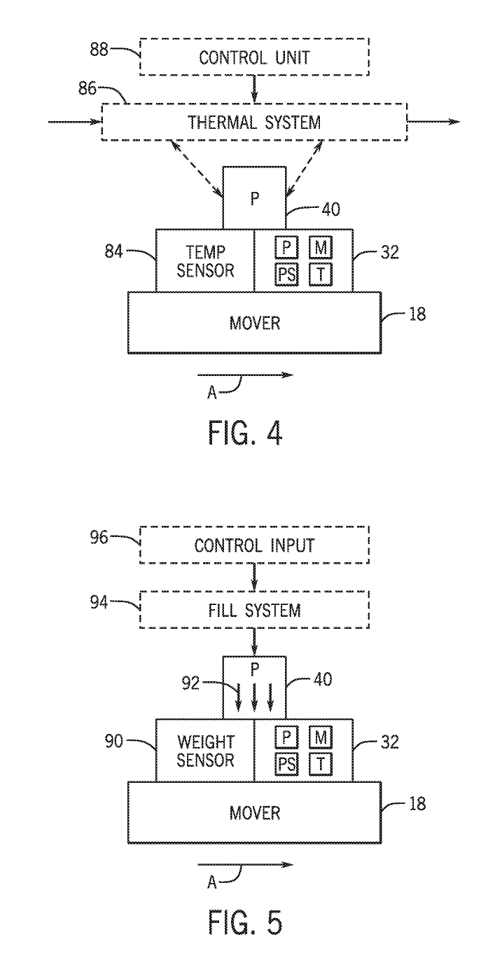

FIG. 4-8 are contemplated embodiments of the various sensors 32 that may be present, in any combination, within the sensor package 34. Once a sensor 32 has sensed a parameter of the mover 18 or payload 40, the data 44 is goes through the transmitting and receiving circuitry described in FIG. 3. Sensing parameters of a payload 40, a mover 18, or anything external to the mover and payload by a sensor 32 that is disposed on each mover may provide a means for identification of each mover as well as allowing closed loop control through feedback of the sensed data 44 through the transmitting and receiving circuitry.

FIG. 4 is one exemplary embodiment wherein the sensor 34 of the sensor package 32 comprises a temperature sensor 84 (e.g., thermistor or thermocouple). The temperature sensor 84 may detect either the temperature of the mover 18, the payload 40, or both whether the mover is stationary or moving in a direction A. Several contemplated embodiments of the present system involving a temperature measurement may include, for example, if the payload requires a maintained, regulated temperature, or monitored temperature. Applications where the present system would be useful may include: curing ceramics, resin, or polymers; cooking; pharmaceuticals. The measured temperature is transmitted to the thermal system 86 which can receive an input from the control input 88 to alter parameters of the mover 18. For example, if the payload 40 is filled with a hot or cool liquid at one location, the change in temperature of the mover 18 or payload 40 could identify which mover is at particular location.

FIG. 5 is another exemplary embodiment wherein the sensor 34 of the sensor package comprises a weight sensor 90. The weight sensor 90 may detect the presence of a payload by its weight 92. For example, an amount of payload 40 may be delivered by a fill system 94, wherein the amount is controlled by a control input 96. The weight sensor 90 detects a change in the weight 92 and transmits this data via the sensor package 32 through the circuitry network presented in FIG. 3. In one exemplary embodiment, this may result in transmitting a signal to stop a fill system 94, or locating a mover 18 by its change in weight 92.

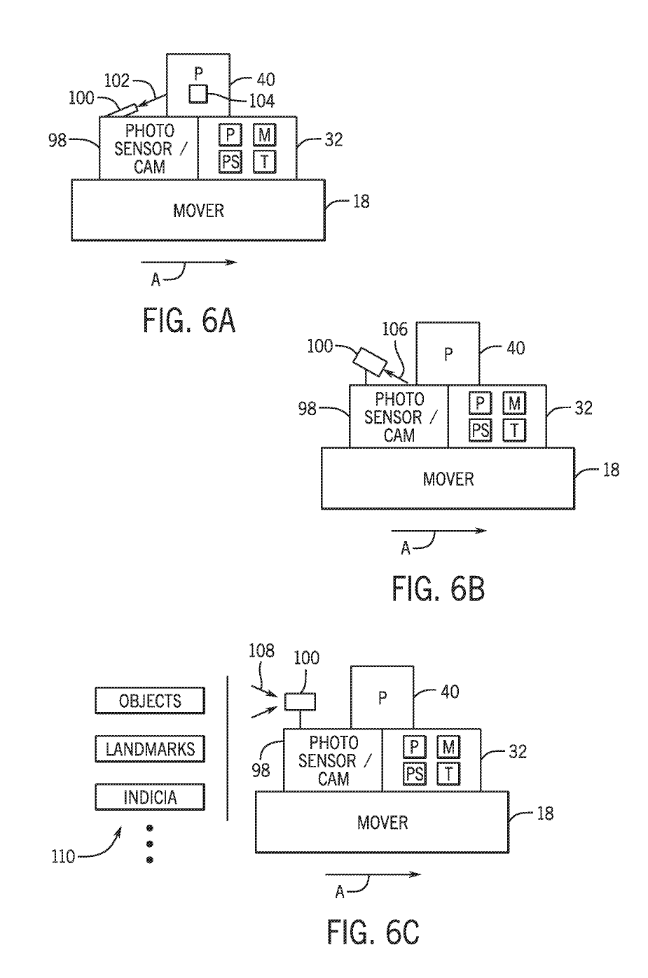

FIG. 6A is another exemplary embodiment wherein the sensor 34 of the sensor package is a photo sensor or camera 98. This sensor may comprise an objective 100 that detects an image 102 of the payload 40 or a tag 104 on the payload. For example, the image 102 may be used for quality assurance of the payload or detection of the image 102 may trigger a signal to move the mover 18 along the direction A to the next location around the track 18. The objective 100 may also detect a tag 104 on the payload that would, for example, allow for identification of the payload.

FIG. 6B is another exemplary embodiment wherein the sensor 34 of the sensor package is a photo sensor or camera 98, comprising an objective 100, that detects an image 106 of the mover 18 or payload 40, in a different configuration than in FIG. 6A. The image 106 may comprise any combination of the mover or the payload, for example, for quality assurance or identification.

FIG. 6C is another exemplary embodiment wherein the sensor 34 of the sensor package is a photo sensor or camera 98. In this example, the objective 100 is oriented to receive an image 108 of a feature or element external to the mover 18. This feature or element may be an object, landmark, or indicia. For example, the objective 100 of the camera/photo sensor may receive an image 108 that indicates the mover 18 or the payload 40 has reached a station along the track. This information may be used to identify the location of the mover 18, which might also be used to transmit a response to a feature such as the fill system 94 or thermal system 86 through their respective control inputs 96 and 88.

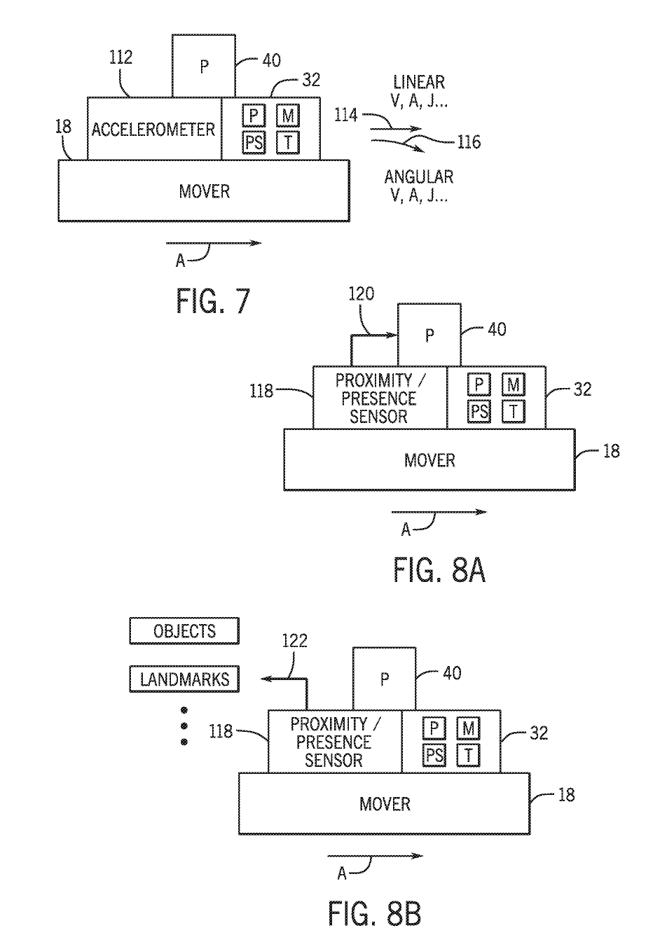

FIG. 7 is an exemplary embodiment wherein the sensor 34 of the sensor package 32 is an accelerometer 112. The accelerometer 112 may sense any combination of the linear 114 or angular 116 velocity, acceleration, and jerk of the mover 118. After sensing one of these parameters, the data 44 may undergo any of the various routines 82 stored in the memory circuitry 80. The data being processed by the various routines may be useful for closed loop control of the mover 18. For example, a mover 18 may receive a payload 40 that would tip over or spill if the speed of the mover goes above a certain amount. The velocity of this mover would be recorded through the transmitting and receiving network discussed in FIG. 3, based on the velocity of the mover before receiving the payload and the threshold velocity determined by a user, for example, a new velocity may be imposed via the drive circuitry.

FIG. 8A is an exemplary embodiment wherein the sensor 34 of the sensor package 32 is a proximity/present sensor 118, and the sensor 34 is configured to detect the presence of a payload 120. Upon the proximity sensor detecting the payload, this data may be logged to through the transmitting and receiving circuitry, or new parameters (temperature, velocity, etc.) may be imposed on the mover via the drive circuitry. Another configuration of the proximity/presence sensor 118 is depicted in FIG. 8B is an exemplary embodiment wherein the sensor 34 of the sensor package 32 is a proximity/present sensor 118, and the sensor 34 is configured to detect the presence of a feature or element external 122 to the mover 18.

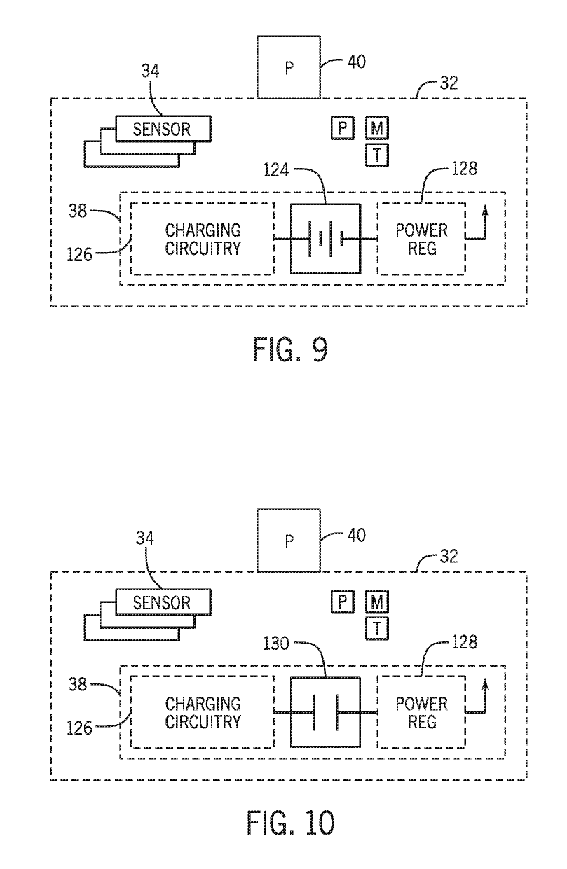

FIG. 9-13 depict various sources of power to the power supply 38 of the sensor package 32. Power may be supplied to the sensor package and its various elements, for example, transmitting circuitry, through a wire connected to a power supply or through a slip ring. In applications where these proposed power supplies are not advantageous to the user, the present invention discloses several alternate power supplies.

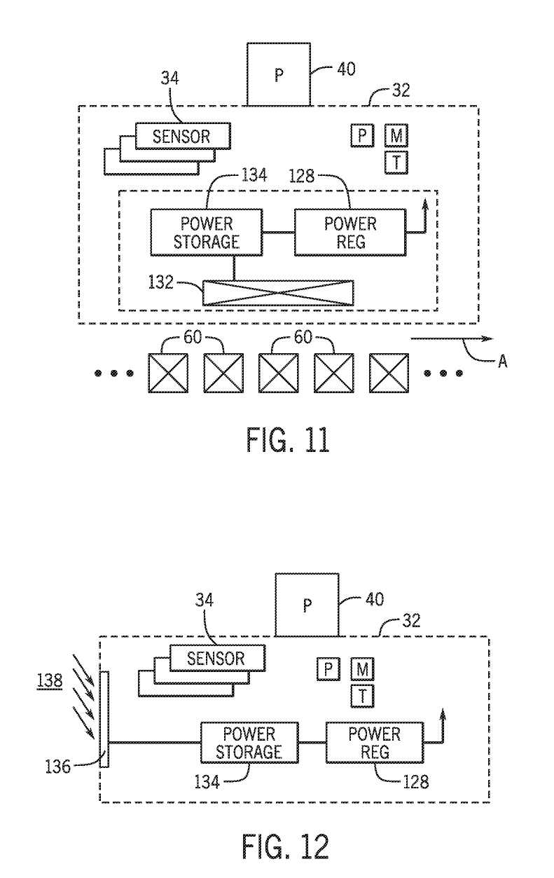

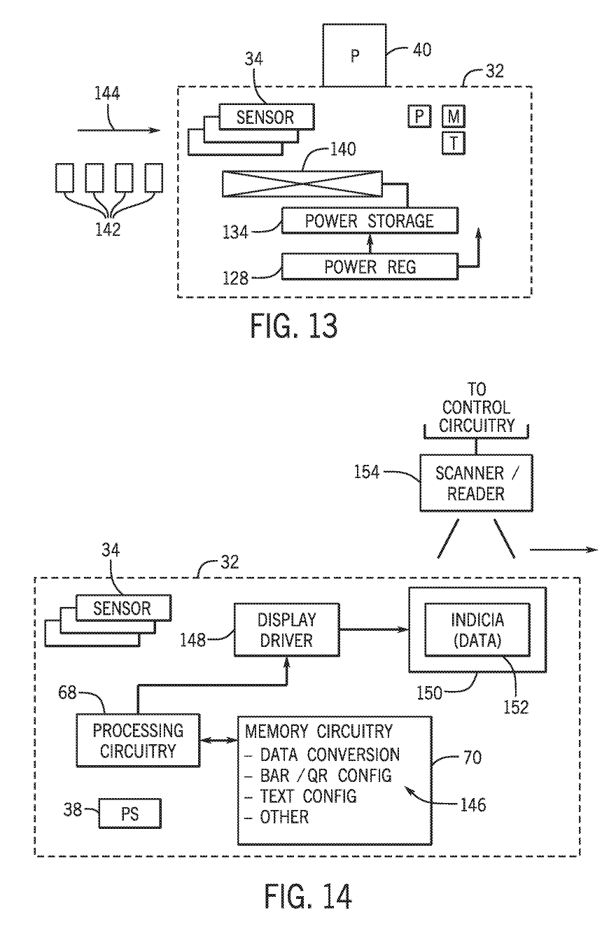

FIG. 9 is an exemplary embodiment wherein the sensor package 32 containing on or more sensors 34 has a power supply 38 comprising a battery 124, a charging circuit 126, and a power regulator 128. In this power supply 38. An alternative power supply 38 is depicted in FIG. 10. In this configuration, the power supply 38. The power supply may also comprise a coil 132 for inductive charging as depicted in FIG. 11. As the sensor package 32 travels in a direction A, it passes over coils 60 that are inductively coupled to the coil 132. In another embodiment, power is supplied by a photocell 136. As the sensor package 32 travels on the mover 18, light 138 incident on the photocell 136 is converted to electricity which is stored in the power storage 134 and utilized by the sensor package 32 via the power regulator 128. In FIG. 13, power is supplied by a coil 140 that passes over magnets 142 along a portion of path 144 of the track 18.

FIG. 14 is a schematic representation of how data is processed and displayed for a scanner/reader 154 that is external to the sensor package 32. As the sensors read parameters of the mover 18, the payload 40, or the any of the previously mentioned external elements, for example, 110, the data is stored in memory circuitry 70 that contains various routines 146, such as: data conversation, or various ways to store and instruct data expression such as in bar/quick response code, or text. Processing circuitry 68 runs the routines 146 stored in the memory circuitry and sends an output to a display driver 148 that. The parameters may be represented as data 152 on a display 150 which is in turn read by a scanner/reader 154 that transmits the data to control circuitry.

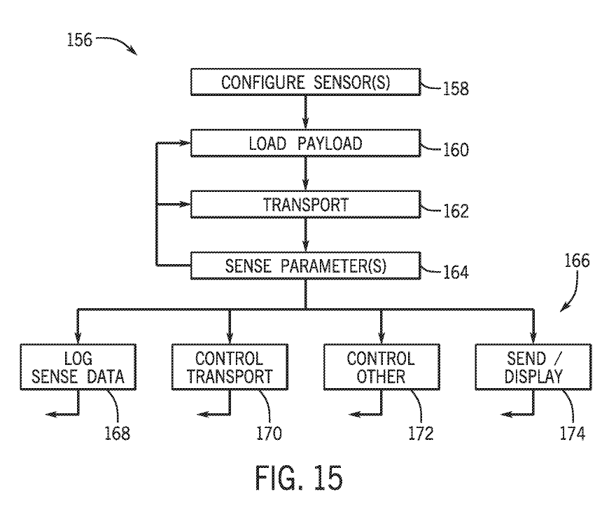

FIG. 15 is a schematic representation of logic 156 for control of the sensors and system. At step 158, the sensors 34 are configured to measure parameters of the mover. At step 160, a payload is loaded onto the mover 18. At step 162, the payload or mover is transported along the track. At step 164, the sensor senses the one of more parameters of the mover 18 or payload 40. Sensing the parameters of the mover 18, payload 40, or both may be done while the payload is being added, for example, to confirm the payload has been added or for a quality assurance check. Sensing parameters may also be carried out while the payload is in motion on the mover, and in some embodiments, at specific times or locations along the track. For example, a mover 18 may transport a payload 40 to a location along the track (e.g., station) where payload is subject to a change in temperature (e.g., heating or cooling), weight (e.g., a fill station), or any of the other various embodiments described in FIG. 4-8. The sensed data may be transmitted to the receiver circuitry as illustrated in FIG. 3. Sensing parameters 164 may result in one or several outcomes 166, in combination or alone. These outcomes provide closed loop control of the linear motor system so as to improve performance while in operation.

In one embodiment, an outcome may be logging the sensed data 168. Logging the sensed data may be important for record keeping or quality assurance. For example, the logged data might include recording an image that indicates the condition of the added payload, weight of the payload at various times or locations along the track, or the change in parameters of the payload 40, mover 18, or both.

In another embodiment, an outcome 166 might include sensing the parameters followed by instructions to control transport 170. For example, an embodiment might be used in a fill system where a weight sensor might be used to confirm the presence of a payload. Upon sensing the change in weight or another parameter that might indicate the presence of a payload, the velocity or acceleration of the mover 18 may be modified so that the payload does not spill. Upon sensing a parameter of the payload 40 that may indicate a removal of the payload, the mover 18 might have its parameters altered again.

In yet another embodiment, an outcome might include control other 172. For example, a payload may be a material requiring heat or light for curing. Upon sensing the payload 18, a signal might be transmitted to activate a heat or light source to initiate curing of the payload.

In another embodiment, an outcome might include instructions to send/display information sensed by the sensors 174. This might enable user feedback with the linear motor system as well as quality control and assurance. For example, a user may access the logged sense data (block 168) as well as any history of events such as control transport 170 or control other 172. As each sensor package 32 may identify each mover 18, the display may include an identifier specific to each mover. In an embodiment such as manufacturing or pharmaceuticals, the display would allow a user to identify which movers either successfully or unsuccessfully accomplished their task. Additionally, this may enable a user to halt operation of the linear motor system.

1. A system comprising:
a linear motor track comprising a plurality of coils and control circuitry that, in operation, selectively energizes the coils to create a motive field;
a mover disposed on the track and comprising a magnet that interacts with the motive field to drive the mover along the track under control of the control circuitry, the mover, in operation, transporting a payload along the track;
a sensor disposed on or in the mover that, in operation, detects a parameter of the mover or of the payload or both;
wireless transmission circuitry coupled to the sensor that, in operation, transmits data based upon the parameter detection by the sensor; and
wireless receiver circuitry on or near the track that, in operation, receives and processes the data transmitted by the wireless transmission circuitry.

2. The system of claim 1, comprising a plurality of sensors disposed on or in the mover that, in operation, detect different respective parameters of the mover or of the payload or both, and wherein the wireless transmission circuitry is coupled to all of the sensors to, in operation, transmit data based upon the parameter detection by the sensors.

3. The system of claim 1, wherein the control circuitry is configured to control movement of the mover in a closed loop manner at least partially based upon the parameter detection by the sensor.

4. The system of claim 1, wherein the sensor comprises a temperature sensor that detects a temperature of the mover, the payload, or both.

5. The system of claim 1, wherein the sensor comprises a weight sensor that detects a weight of the mover, the payload, or both.

6. The system of claim 1, wherein the sensor comprises a photosensor or a camera that detects a feature of the mover, the payload, or both.

7. The system of claim 1, wherein the sensor comprises an accelerometer that detects motion of the mover, the payload, or both.

8. The system of claim 1, wherein the sensor comprises a proximity or presence sensor that detects proximity or presence of the mover, the payload, or both, or of an object on or near the mover, the payload, or both.

9. The system of claim 1, comprising an onboard power supply on or in the mover to provide power to the sensor and to the transmission circuitry.

10. The system of claim 9, wherein the onboard power supply comprises a battery that provides power for operation of the sensor, the transmission circuitry, or both.

11. The system of claim 9, wherein the onboard power supply comprises a capacitor that provides power for operation of the sensor, the transmission circuitry, or both.

12. The system of claim 9, wherein the onboard power supply comprises a power scavenging circuit that scavenges power from the coils to power operation of the sensor, the transmission circuitry, or both.

13. The system of claim 9, wherein the onboard power supply comprises a photocell that provides power for operation of the sensor, the transmission circuitry, or both.

14. The system of claim 9, wherein the onboard power supply comprises a power coil that provides power for operation of the sensor, the transmission circuitry, or both by generating power by proximity with a magnet on or adjacent to the track.

15. The system of claim 1, comprising a display on or in the mover that encodes and/or displays indicia based upon the data.

16. The system of claim 15, wherein the indicia are machine readable to convey the data to a reader on or near the track.

17. The system of claim 1, wherein the sensor detects unique identifying data for the payload.

18. A system comprising:
a mover configured to be disposed on a linear motor track that comprises a plurality of coils and control circuitry that, in operation, selectively energizes the coils to create a motive field, the mover comprising a magnet that interacts with the motive field to drive the mover along the track under control of the control circuitry, the mover, in operation, transporting a payload along the track;
a sensor disposed on or in the mover that, in operation, detects a parameter of the mover or of the payload or both; and
wireless transmission circuitry coupled to the sensor that, in operation, transmits data to receiver circuitry on or near the track based upon the parameter detection by the sensor.

19. A method comprising:
disposing a mover on a linear motor track that comprises a plurality of coils and control circuitry that, in operation, selectively energizes the coils to create a motive field, the mover comprising a magnet that interacts with the motive field to drive the mover along the track under control of the control circuitry, the mover, in operation, transporting a payload along the track;
detecting a parameter of the mover or of the payload or both via a sensor disposed on or in the mover; and
wirelessly transmitting data from the mover to receiver circuitry on or near the track based upon the parameter detection by the sensor.

20. The method of claim 19, comprising controlling movement of the mover in a closed loop manner via the control circuitry at least partially based upon the parameter detection by the sensor.
